(19) United States
(12) Patent Application Publication
(10) Pub. No.: US 2025/0262856 A1
(43) Pub. Date: Aug. 21, 2025

(54) LIQUID EJECTION HEAD

(71) Applicant: CANON KABUSHIKI KAISHA, Tokyo (JP)

(72) Inventors: HIROAKI SASAKI, Saitama (JP); HIKARU SUGIMOTO, Kanagawa (JP)

(21) Appl. No.: 19/052,600

(22) Filed: Feb. 13, 2025

(30) Foreign Application Priority Data
Feb. 19, 2024 (JP) 2024-022601

(51) Int. Cl. B41J 2/16; B41J 2/045; B41J 2/14; C09J 11/06; C09J 123/22

(52) U.S. Cl. CPC B41J 2/1606; B41J 2/04525; B41J 2/04581; B41J 2/14201; B41J 2/1623; C09J 11/06; C09J 123/22

(57) ABSTRACT

A liquid ejection head comprising an ejection port for ejecting liquid; a pressure chamber in which pressure acts on the liquid ejected from the ejection port; a flow path communicating with the pressure chamber; a substrate forming the flow path; and an organic film for constituting a part of a wall surface of the flow path and suppressing vibration of the liquid in the flow path, wherein the organic film is adhered, with an adhesive, to the substrate, and the organic film and the adhesive are bonded through a siloxane bond.

### BACKGROUND OF THE INVENTION

### Field of the Invention

The present disclosure relates to a liquid ejection head.

### Description of the Related Art

A flow path member, which is a fine structure, is used in, for example, a liquid ejection head of an inkjet recording device. An inkjet recording device is a recording device that ejects ink from nozzles of a liquid ejection head that ejects liquid to form characters and images on a medium. For example, in a piezoelectric inkjet recording device, a piezoelectric element is installed at a position facing a pressure chamber that communicates with a nozzle that ejects liquid, with a vibration plate being interposed between the piezoelectric element and the pressure chamber.

By applying a voltage to the piezoelectric element, the piezoelectric element and the vibration plate are displaced, and the volume of the pressure chamber changes, causing the liquid to be ejected from the nozzle. The vibration of the vibration plate is transmitted to adjacent nozzles through the liquid in the liquid flow path, which is called crosstalk, and this may cause poor ejection of liquid from the adjacent nozzles.

### SUMMARY OF THE INVENTION

Accordingly, a means for providing a damper in the flow path member so as to face the piezoelectric element is used. This damper needs to have ink resistance, heat resistance that can withstand the curing temperature of an adhesive, and an elastic modulus and film thickness suitable for functioning as a damper film. Materials that satisfy these characteristics can be exemplified by polyimides, LCP, and the like, but these materials are often difficult to adhere with adhesives. In addition, since the damper is provided in a flow path member that adheres to a recording element substrate, it is necessary to adhere the damper by using an adhesive in a pre-process. However, there are problems with the adherence reliability between the adhesive and the damper film.

WO 2020/045112 discloses using a film comprising a heat-resistant resin, for example a polyimide, and a resin composition, for example benzocyclobutene (BCB), and presents a technique in which the film comprising the heat-resistant resin is subjected to surface treatment, such as a plasma treatment, to generate ester bonds with the resin composition and improve adherence.

However, when the inventors of the present invention investigated the adherence of the member having the ester bond described in WO 2020/045112, the inventors confirmed that the bond between the organic film as a damper film and the adhesive deteriorates over time when the organic film is immersed in ink. Therefore, the adhesion is insufficient to use the technique of WO 2020/045112 in an inkjet recording device that is constantly in contact with ink, and there is a risk that the organic film and the adhesive will peel off in a short time.

The present disclosure is directed to a liquid ejection head in which the initial adhesive strength of the adhesive to the organic film is high and the adhesive strength is not likely to decrease even when the organic film is immersed in ink.

The present disclosure relates to a liquid ejection head comprising:
an ejection port for ejecting liquid;
a pressure chamber in which pressure acts on the liquid ejected from the ejection port;
a flow path communicating with the pressure chamber;
a substrate forming the flow path; and
an organic film for constituting a part of a wall surface of the flow path and suppressing vibration of the liquid in the flow path, wherein
the organic film is adhered, with an adhesive, to the substrate, and
the organic film and the adhesive are bonded through a siloxane bond.

According to the present disclosure, it is possible to provide a liquid ejection head in which the initial adhesive strength of the adhesive to the organic film is high and the adhesive strength is not likely to decrease even when the organic film is immersed in ink.

Further features of the present invention will become apparent from the following description of exemplary embodiments with reference to the attached drawings.

### BRIEF DESCRIPTION OF THE DRAWINGS

FIG. 1 is a schematic cross-sectional view of a liquid ejection head;

FIG. 2 is a schematic view illustrating die shear measurement; and

FIGS. 3A to 3I illustrate an example of the organic film formation process.

### DESCRIPTION OF THE EMBODIMENTS

In the present disclosure, the expression of “from XX to YY” or “XX to YY” indicating a numerical range means a numerical range including a lower limit and an upper limit which are end points, unless otherwise specified. Also, when a numerical range is described in a stepwise manner, the upper and lower limits of each numerical range can be arbitrarily combined. In addition, in the present disclosure, for example, descriptions such as “at least one selected from the group consisting of XX, YY and ZZ” mean any of XX, YY, ZZ, the combination of XX and YY, the combination of XX and ZZ, the combination of YY and ZZ, and the combination of XX, YY, and ZZ.

Hereinafter, the embodiments of the present disclosure will be described with reference to the drawings. The following embodiments do not limit the present disclosure, and not all combinations of features described in the present embodiments are necessarily essential to the present disclosure. The same components may be given the same reference numbers.

### Liquid Ejection Head

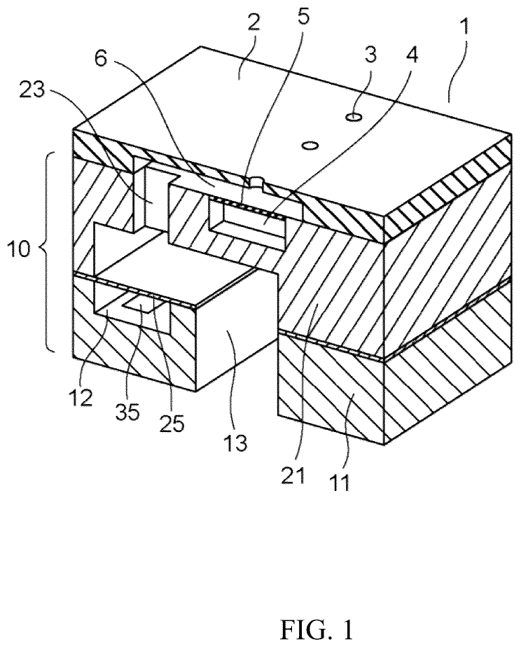

FIG. 1 is a schematic cross-sectional view of a liquid ejection head equipped with a flow path member 10 according to the first embodiment. The liquid ejection head 1 is manufactured by joining the flow path member 10 and a nozzle plate 2 equipped with an ejection port 3 for ejecting liquid. The liquid ejection head 1 is suitable for an inkjet recording head mounted on a recording device that ejects ink to form characters and images on a medium.

The flow path member 10 is formed by joining a first substrate 11 having a recess 12 and a first flow path 13 to a second substrate 21 for forming a second flow path 23 that communicates with an organic film 25. Thus, the liquid ejection head is provided with a substrate that forms the flow path 13. The first substrate 11 is formed so that the organic film 25 that functions as a damper film for suppressing vibration of the liquid covers the recess 12. In addition to the second flow path 23, the second substrate 21 has an ejection element 4 that generates pressure to eject the liquid from the ejection port 3, and a pressure chamber 6 in which the pressure generated by the ejection element 4 acts on the liquid.

The first substrate 11 and the second substrate 21 are joined to form the flow path member 10, and the liquid that has flowed through the first flow path 13 is supplied to the pressure chamber 6 through the second flow path 23. The liquid is ejected from the ejection port 3 by the action of pressure generated by the ejection element 4 on the liquid supplied to the pressure chamber 6.

The ejection element 4 may be a piezoelectric element that is displaced by application of voltage, or a thermoelectric transducer that generates heat by application of voltage. When the ejection element 4 is a piezoelectric element, it is preferable to have a vibration plate 5 between the piezoelectric element and the pressure chamber 6. By having the vibration plate 5, the displacement of the piezoelectric element is easily transmitted to the liquid in the pressure chamber 6. In an inkjet recording head equipped with a piezoelectric element, as described above, the vibration is transmitted to adjacent ejection ports through the liquid in the flow path, so-called crosstalk, which may cause poor ejection of the liquid from the adjacent ejection ports.

The flow path member 10 has the organic film 25 that can function as a damper film. When the vibration of the ejection element 4 or the vibration plate 5 is transmitted to the organic film 25 through the liquid in the second flow path 23, the organic film 25 acts as a damper and can suppress the vibration of the liquid. Therefore, the organic film 25 can suppress crosstalk. That is, the liquid ejection head according to the present disclosure is suitable for the case where the ejection element that is prone to crosstalk is a piezoelectric element. In addition, the recess 12 is provided with an air communication hole 35 for communicating with the atmosphere.

Therefore, for example, the liquid ejection head 1 comprises the ejection port 3 for ejecting liquid, the pressure chamber 6 in which pressure acts on the liquid to be ejected from the ejection port 3, and the flow path 13 that communicates with the pressure chamber 6. The liquid ejection head 1 also comprises the organic film 25 for constituting a part of the wall surface of the flow path 13 and suppressing vibration of the liquid in the flow path 13. The liquid ejection head 1 also comprises an ejection element 4 that generates pressure, and the ejection element 4 is preferably a piezoelectric element.

The organic film 25 is adhered to the substrate with an adhesive. For example, in FIG. 1, the first substrate 11 and the second substrate 21 are joined to each other with the organic film 25 interposed therebetween. In this case, for example, the following (A) and/or (B) is satisfied.
(A) The first substrate 11 and the organic film 25 are adhered to each other with an adhesive.
(B) The second substrate 21 and the organic film 25 are adhered to each other with an adhesive.

This embodiment is not limiting as long as the organic film is adhered to the substrate with an adhesive.

The organic film and the adhesive are bonded through siloxane bonds. The inventors have found that by bonding the organic film and the adhesive through siloxane bonds, the initial adhesive strength of the adhesive to the organic film is high, and the adhesive strength is unlikely to decrease even when the film is immersed in ink. This is thought to be because the water repellency and oil repellency of the siloxane bonds are higher than those of other bonds such as ester bonds, and therefore durability against ink is improved. Thus, no particular limitation is placed on the ink, and water-based ink and organic ink can be applied. An example of an organic ink is an acrylic ink.

### Organic Film

The organic film 25 is required to have ink resistance and heat resistance equal to or above the thermal curing temperature of the adhesive. As the organic film 25, super engineering plastics such as polyimides, epoxy resins, liquid crystal polymer resins (LCP), polyether ether ketone (PEEK), and polyetherimides (PEI) can be mentioned as candidates. In addition, polyamides are difficult to use with ink types comprising acrylic monomers from the viewpoint of ink resistance but can be used with water-based inks such as latex inks. The organic film 25 preferably comprises at least one selected from the group consisting of polyimides and epoxy resins. The organic film 25 more preferably comprises a polyimide.

It is more preferable that functional groups be generated on the surface of the organic film because the reactivity with the silane agent described hereinbelow is increased and the bonding performance between the organic film and the silane agent is enhanced. Methods for increasing the number of functional groups on the surface of the organic film include plasma treatment and chemical treatment as shown in WO 2020/045112. It is preferable that the part of the organic film that is in contact with the adhesive be plasma treated. In addition to generating functional groups on the film surface to form a silane agent layer, an organic film in which a silane agent is added to the resin in advance so that the silane agent, which has reacted with the functional groups in the resin, be present on the film surface after the solvent volatilizes or after curing may be used.

Furthermore, when the organic film is used as a damper film, the elastic modulus of the organic film is preferably 15 GPa or less, and more preferably 10 GPa or less in order to express the damper performance. Although there is no particular lower limit, the elastic modulus of the organic film is preferably 3 GPa or more, and more preferably 4 GPa or more.

From the viewpoint of exerting damping performance, the thickness of the organic film is preferably 10 μm or less, and more preferably 7 μm or less. Although there is no particular lower limit, the thickness of the organic film is preferably 1 μm or more, and more preferably 1.5 μm or more.

As a result of intensive research by the present inventors, it has been found that polyimides are particularly preferable for the organic film from the viewpoint of high ink resistance against many types of ink, elastic modulus, and film formability making it possible to form a desired film thickness. Examples of monomers that can be used to prepare polyimides include diamines, triamines, carboxylic dianhydrides, and carboxylic trianhydrides.

Examples of diamines include phenylenediamine and derivatives thereof, diaminobiphenyl compounds and derivatives thereof, diaminodiphenyl compounds and derivatives thereof, diaminotriphenyl compounds and derivatives thereof, diaminonaphthalene and derivatives thereof, aminophenyl aminoindan and derivatives thereof, diaminotetraphenyl compounds and derivatives thereof, diaminohexaphenyl compounds and derivatives thereof, and cardo-type fluorenediamine derivatives.

Specifically, examples of diamines include 3,3′-dimethyl-4,4′-diaminobiphenyl, 2,2′-dimethyl-4,4′-diaminobiphenyl, 2,2′-bis(trifluoromethyl)-4,4′-diaminobiphenyl, 3,3′-dimethyl-4,4′-diaminodiphenylmethane, 3,3′-dicarboxy-4,4′-diaminodiphenylmethane, 3,3′,5,5′-tetramethyl-4,4′-diaminodiphenylmethane, bis(4-aminophenyl) sulfide, 4,4′-diaminobenzanilide, dimethylbenzidine, 3,3′-dimethoxybenzidine, 2,2′-dimethoxybenzidine, 3,3′-diaminodiphenyl ether, 3,4′-diaminodiphenyl ether, 4,4′-diaminodiphenyl ether, 3,3′-diaminodiphenyl sulfide, oxydianiline, 3,4′-diaminodiphenyl sulfide, 4,4′-diaminodiphenyl sulfide, 3,3′-diaminodiphenyl sulfone, 3,4′-diaminodiphenyl sulfone, 4,4′-diaminodiphenyl sulfone, 3,3′-diaminobenzophenone, 3,3′-diamino-4,4′-dichlorobenzophenone, 3,3′-diamino-4,4′-dimethoxybenzophenone, 3,3′-diaminodiphenylmethane, 3,4′-diaminodiphenylmethane, 4,4′-diaminodiphenylmethane, 2,2-bis(3-aminophenyl)propane, 2,2-bis(4-aminophenyl)propane, 2,2-bis(3-aminophenyl)-1,1,1,3,3,3-hexafluoropropane, 2,2-bis(4-aminophenyl)-1,1,1,3,3,3-hexafluoropropane, 3,3′-diaminodiphenyl sulfoxide, 3,4′-diaminodiphenyl sulfoxide, 4,4′-diamino-3,3′-dimethyldiphenylmethane, and 4,4′-diaminodiphenyl sulfoxide.

Other examples of diamines include 1,3-bis(3-aminophenyl)benzene, 1,3-bis(4-aminophenyl)benzene, 1,4-bis(3-aminophenyl)benzene, 1,4-bis(4-aminophenyl)benzene, and 1,3-bis(4-aminophenoxy)benzene, 3,3′-bis(3-aminophenoxy)biphenyl, bis[3-(3-aminophenoxy)phenyl]methane, bis[3-(4-aminophenoxy)phenyl]methane, 9,9-bis(4-aminophenyl)fluorene, bis[4-(3-aminophenoxy)phenyl]methane, bis[4-(4-aminophenoxy)phenyl]methane, 2,2-bis[3-(3-aminophenoxy)phenyl]propane, 2,2-bis[3-(4-aminophenoxy)phenyl]propane, 2,2-bis[4-(3-aminophenoxy)phenyl]propane, 2,2-bis[4-(4-aminophenoxy)phenyl]propane, and 2,2-bis[3-(3-aminophenoxy)phenyl]-1,1,1,3,3,3-hexafluoropropane. These diamines may be used alone or in combination of two or more.

Examples of carboxylic acid anhydrides include pyromellitic dianhydride, 1,1-bis(2,3-dicarboxyphenyl)ethane dianhydride, bis(2,3-dicarboxyphenyl)methane dianhydride, bis(3,4-dicarboxyphenyl)methane dianhydride, 3,3′,4,4′-biphenyltetracarboxylic dianhydride, 2,3,3′,4′-biphenyltetracarboxylic dianhydride, 2,2,6,6-biphenyltetracarboxylic dianhydride, 2,2-bis(3,4-dicarboxyphenyl)propane dianhydride, 2,2-bis(2,3-dicarboxyphenyl)propane dianhydride, 2,2-bis(3,4-dicarboxyphenyl)-1,1,1,3,3,3-hexafluoropropane dianhydride, 2,2-bis(2,3-dicarboxyphenyl)-1,1,1,3,3,3-hexafluoropropane dianhydride, 3,3′,4,4′-benzophenonetetracarboxylic acid dianhydride, bis(3,4-dicarboxyphenyl)ether dianhydride, bis(2,3-dicarboxyphenyl)ether dianhydride, 2,2′,3,3′-benzophenonetetracarboxylic dianhydride, oxydiphthalic anhydride, 4,4-(p-phenylenedioxy)diphthalic dianhydride, 4,4-(m-phenylenedioxy)diphthalic dianhydride, 1,2,5,6-naphthalenetetracarboxylic dianhydride, 1,4,5,8-naphthalenetetracarboxylic acid, 2,3,6,7-naphthalenetetracarboxylic dianhydride, 1,2,3,4-benzenetetracarboxylic dianhydride, 3,4,9,10-perylenetetracarboxylic dianhydride, 2,3,6,7-anthracenetetracarboxylic dianhydride, 1,2,7,8-phenanthrenetetracarboxylic dianhydride, 9,9-bisphthalic anhydride fluorene, 3,3′,4,4′-diphenylsulfonetetracarboxylic dianhydride, and the like.

Examples of the aliphatic tetracarboxylic dianhydrides include ethylenetetracarboxylic dianhydride, butanetetracarboxylic dianhydride, cyclopentanetetracarboxylic dianhydride, cyclohexanetetracarboxylic dianhydride, 1,2,4,5-cyclohexanetetracarboxylic dianhydride, 1,2,3,4-cyclohexanetetracarboxylic dianhydride, and the like. These may be used alone or in combination of two or more.

The polyimide is preferably an imide of polyamic acid made of diamine and carboxylic anhydride. The polyamic acid may be commercially available, for example, polyamic acid solution PI2610 (product name: manufactured by HD Microsystems, Inc.).

The epoxy resin is not particularly limited, and known epoxy resins may be used. The epoxy resin is preferably a photosensitive epoxy resin and is preferably a cured product of an epoxy resin composition comprising a bifunctional or higher functional epoxy resin and a photoacid generator. As the bifunctional or higher functional epoxy resin, EPICLON N695 (DIC Corporation), jER 1009F (Mitsubishi Chemical Corporation), etc. may be used.

### Silane Agent

A silane agent may be used between the organic film and the adhesive. The silane agent is, for example, a silane coupling agent. There are no particular limitations on the silane agent, but those that have a functional group that can react with the aforementioned organic film are more preferable because a chemical bond will be formed between the organic film and the silane agent, thereby increasing the adhesive force.

It is therefore preferable that the adherence between the organic film and the adhesive comprises bonds through a silane agent.

More specifically, it is preferable that the liquid ejection head comprise bonds represented by the following formula (1) in addition to the siloxane bonds between the organic film and the adhesive.

—C1-X—C2- (1)

In formula (1), X is at least one selected from the group consisting of —CO—NH—, —CH₂—CHOH—CH₂—O—CO—CH₂—CH₂—, —CHOH—CH₂—N—, —CH₂—(CH₂—O—CH₂)n-CH₂—, —CO—O—, —CO—S—, —O—, and —NH—CO—O—, n is the average number of moles added and represents an integer of 1 to 200 (preferably 10 to 200), and C1 and C2 are each independently a carbon atom.

X is more preferably at least one selected from the group consisting of —CO—NH—, —CH₂—CHOH—CH₂—O—CO—CH₂—CH₂—, —CHOH—CH₂—N—, and —CH₂—(CH₂—O—CH₂)n-CH₂—.

A method for confirming the bonds between the organic film and the adhesive is not particularly limited, and known means can be used. Examples include etching of the organic surface with an argon cluster ion beam and time-of-flight secondary ion mass spectrometry (TOF-SIMS).

For example, when a polyimide film is used as the organic film, it is known that a carboxylic acid is generated on the polyimide surface after plasma treatment. Therefore, when the silane agent has an amino group, an epoxy group, or a hydroxyl group, chemical bonds such as amide bonds, epoxy ester bonds, and ester bonds, respectively, are generated between the silane agent and the polyimide, and therefore silane agents having these functional groups are suitable examples.

For example, the silane agent can be applied to the portion of the organic film, which is to be adhered to the adhesive, and heated to bond the organic film and the silane agent.

The organic film may also comprise a silane agent. For example, where a silane agent is added in advance to the resin to be used for the organic film, a silane agent having a functional group capable of reacting with the functional group in the resin may be used.

A leaving group of the silanol group is not particularly limited and may be any group that is hydrolyzed by water, such as a methoxy group or an ethoxy group.

Taking these factors into consideration, the silane agent can be exemplified by at least one silane coupling agent selected from the group consisting of 2-(3,4-epoxycyclohexyl)ethyltrimethoxysilane, 3-glycidoxypropylmethyldimethoxysilane, 3-glycidoxypropyltrimethoxysilane, 3-glycidoxypropylmethyldiethoxysilane, 3-glycidoxypropyltriethoxysilane, N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethylbutylidene)-propylamine, N-phenyl-3-aminopropyltrimethoxysilane, N-(vinylbenzyl)-2-aminoethyl-3-aminopropyltrimethoxysilane hydrochloride, 3-ureidopropyltrialkoxysilane, 3-mercaptopropylmethyldimethoxysilane, 3-mercaptopropylmethoxysilane, 3-isocyanatepropyltriethoxysilane, 3-isocyanatepropyltriethoxysilane, 3-trimethoxysilylpropylsuccinic anhydride, and the like.

The silane agent preferably comprises at least one selected from the group consisting of an aminosilane agent and an epoxy silane agent, and more preferably comprises an aminosilane agent. The aminosilane agent makes it easier to maintain adhesion when immersed in an organic ink.

The aminosilane agent is preferably at least one selected from the group consisting of N-2-(aminoethyl)-3-aminopropylmethyldimethoxysilane, N-2-(aminoethyl)-3-aminopropyltrimethoxysilane, 3-aminopropyltrimethoxysilane, 3-aminopropyltriethoxysilane, 3-triethoxysilyl-N-(1,3-dimethylbutylidene)-propylamine, N-phenyl-3-aminopropyltrimethoxysilane, and N-(vinylbenzyl)-2-aminoethyl-3-aminopropyltrimethoxysilane hydrochloride.

Commercially available aminosilane agents may be used, for example VM-652 (manufactured by HD Microsystems, Inc.).

The epoxy silane agent can be exemplified by 2-(3,4-epoxycyclohexyl)ethyltrimethoxysilane, 3-glycidoxypropylmethyldimethoxysilane, and 3-glycidoxypropyltriethoxysilane.

Commercially available epoxy silane agents may be used, for example AP3000 (DuPont), KBM-402 (Shin-Etsu Chemical Co., Ltd.), and KBE-403 (Shin-Etsu Chemical Co., Ltd.).

### Adhesive

The adhesive may be any adhesive capable of bonding the organic film and the adhesive through siloxane bonds. There are no particular limitations on the bonding means. When treating the surface of the organic film with a silane agent, an adhesive that forms a siloxane bond with the silane agent may be used. Alternatively, an adhesive having a siloxane bond in the structure may be used to bond the adhesive to the organic film, thereby bonding the organic film and the adhesive through siloxane bonds. Alternatively, a functional group may be formed on the surface of the organic film, and an adhesive having a siloxane bond may be bonded to the functional group. The organic film and the adhesive may be bonded through a silane agent that is capable of bonding to the organic film and the adhesive and has a siloxane bond.

From the viewpoint of water repellency, an adhesive with a lower percentage of oxygen atoms is preferred. Examples of adhesives include at least one selected from the group consisting of silsesquioxane derivatives, divinylsiloxane-bisbenzocyclobutene, dimethylpolysiloxane, tetramethylcyclotetrasiloxane, and the like. These may be used alone or in combination of two or more.

The adhesive preferably comprises a resin comprising a cyclobutene skeleton. It is more preferable that the adhesive comprise divinylsiloxane-bisbenzocyclobutene. When divinylsiloxane-bisbenzocyclobutene is used, the silane agent and the adhesive can be reacted to form a bond including a siloxane bond after the organic film treated with the silane agent and the substrate are adhered to each other through the adhesive. For example, the reaction between the silane agent and the adhesive can be accelerated by heating. In addition, YL9028 (Mitsubishi Chemical Corporation) is also preferable as an adhesive having a siloxane bond Si—O—Si in the structure.

### Substrate

The substrate is not particularly limited as long as it has adherence reliability. Suitable examples include a silicon wafer and a substrate in which a film of at least one selected from the group consisting of SiC, SiN, and SiO is formed on a silicon wafer. The aforementioned organic film may also be used as an adherend.

### Method for Producing Liquid Ejection Head

An example of a method for producing a liquid ejection head will be described. In the following explanation, an example of the formation of a flow path member and an organic film will be mainly described. In the following example of a method for producing a liquid ejection head, the substrate to which the organic film is adhered with an adhesive is the second substrate 21.

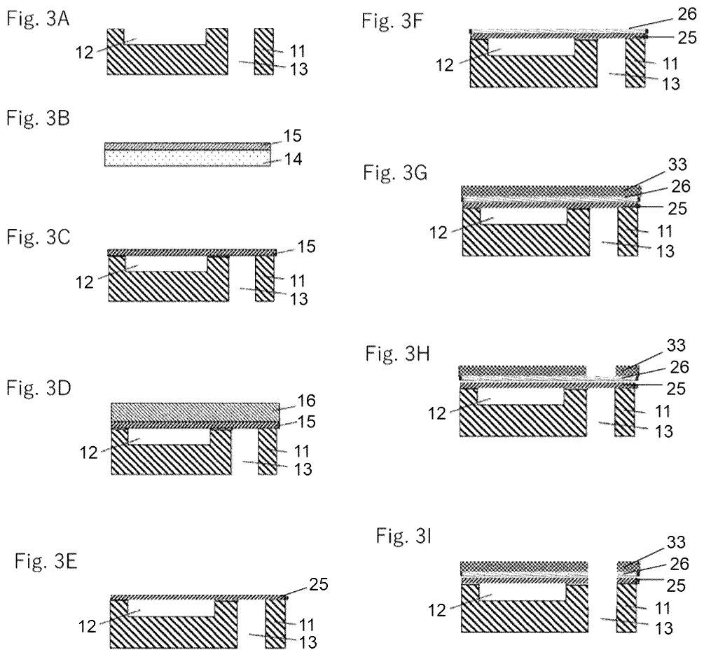

First, a first substrate 11 is prepared. Then, as shown in FIG. 3A, a recess 12 and a first flow path 13 through which a fluid will flow are formed in the first substrate 11. The recess 12 etc. may be formed by any known means, such as silicon deep-dry etching.

The surface of the first substrate 11 may be treated with a silane coupling agent. This can improve the adhesion between the first substrate and the organic film.

Next, an organic film is formed on the prepared first substrate 11. For example, an attachment member on which a polyamic acid film has been formed can be obtained, and the polyamic acid film can be transferred to the first substrate and heated to form a polyimide film, which is an organic film. As shown in FIG. 3B, a solution comprising a polyamic acid is applied onto a PET film, which is an attachment member 14. Then, for example, the substrate is heated at 120 to 250° C., preferably 130 to 200° C., for preferably 5 to 30 min, thereby forming a polyamic acid film 15.

Next, as shown in FIG. 3C, the polyamic acid film 15 is transferred and attached to the first substrate 11 so as to cover the recess 12 and the first flow path 13. Then, as shown in FIG. 3D, the polyamic acid film 15 attached to the first substrate 11 is baked for imidization while being supported by a support member 16. For example, a silicon substrate can be used as the support member 16. There is no particular limitation on the means of baking for imidization. The temperature is preferably 300 to 400° C., and more preferably 320 to 380° C. The time is, for example, 10 to 300 min, preferably 30 to 200 min. The polyamic acid film 15 reacts to the polyimide film 25 by the heat treatment.

Next, as shown in FIG. 3E, the support member 16 is removed. For example, it can be removed by etching after thinning by grinding. As a result, a flow path member having the polyimide film 25 arranged as a damper film to cover the recess 12 and the first flow path 13 is formed.

Next, the surface of the organic film to be adhered to the adhesive is treated with plasma. The outer surface of the polyimide film 25 in FIG. 3E is treated with plasma. Specifically, the portion to be in contact with the adhesive is treated with plasma. This allows functional groups to be generated on the surface of the organic film, which makes it easier to react with the silane agent. As the plasma treatment, for example, a hydrophilic treatment by oxygen plasma irradiation using active oxygen can be used.

Then, the surface of the organic film treated with plasma is treated with a silane agent. This process allows bonds to be formed between the silane agent and the organic film. For example, a silane agent layer is formed on the surface of the organic film that has been treated with plasma. As shown in FIG. 3F, a silane agent is applied onto the polyimide film 25 by a known application method such as spin coating to form a silane agent layer 26. Furthermore, heating may be performed at, for example, 70 to 120° C. for 30 to 300 sec. This can promote the reaction between the functional groups on the surface of the polyimide film 25 and the silane agent.

Next, a flow path is formed in the organic film. If necessary, a photoresist layer may be provided to protect areas other than the flow path. As shown in FIG. 3G, in order to prevent the polyimide film 25 and the silane agent layer 26 formed on areas other than the first flow path 13 from being removed, a positive photoresist 33 that serves as an etching mask is formed on the silane agent layer 26. Then, as shown in FIG. 3H, the photoresist 33 formed on the first flow path 13 is removed by photolithography. Furthermore, as shown in FIG. 3I, the polyimide film 25 and the silane agent layer 26 on the first flow path 13 are removed by chemical dry etching to communicate the flow path with the organic film.

Next, in order to form the second flow path 23 in FIG. 1, the first substrate 11 and the second substrate 21 are joined together. That is, the organic film on the first substrate 11 and the second substrate 21 are joined together through an adhesive. Specifically, the organic film and the second substrate 21 are bonded with an adhesive, and the organic film and the adhesive are bonded through siloxane bonds. The method of forming bonds via siloxane bonds is as described above.

Described above is an example of a method for producing a liquid ejection head. The method for producing a liquid ejection head preferably includes a step of performing plasma treatment of the surface of the organic film to be adhered to the adhesive, a step of treating the surface of the organic film that has been plasma treated with a silane agent, and a step of adhering the organic film and the substrate with an adhesive, and bonding the organic film and the adhesive through siloxane bonds.

### EXAMPLES

The present disclosure will be described in more detail hereinbelow with reference to Examples and Comparative Examples, but the present disclosure is not limited thereto.

### Production Example of Liquid Ejection Head

An example of forming a flow path member and an organic film in relation to the production of a liquid ejection head is described hereinbelow.

FIGS. 3A to 3I are cross-sectional views illustrating a method for producing a flow path member of the first embodiment. First, as shown in FIG. 3A, the first substrate 11 for forming the recess 12 and the first flow path 13 through which a fluid will flow was prepared. For the first substrate 11, single crystal silicon with dimensions of 200 mmφ and 500 μm thickness was used.

To improve the adhesion between the first substrate 11 and the polyamic acid film 15 described below, a silane coupling agent VM-652 (manufactured by HD Microsystems, Inc.) was applied to the surface of the first substrate 11 under conditions of 2000 rpm and 30 sec. A silane agent layer was then formed on the surface of the first substrate 11 by heating on a hot plate at 90° C. for 90 sec.

Then, silicon deep dry etching was used to form the recess 12 and the first flow path 13 with a rectangular planar shape and a short-side width of 600 μm (FIG. 3A).

Next, as shown in FIG. 3B, a polyamic acid solution PI2610 (HD Microsystems, Inc.) was applied by spin coating (conditions: 2500 rpm, 30 sec) onto a 100 μm-thick PET film, which was the attachment member 14. Then, the polyamic acid film 15 was formed to a thickness of 5 μm by baking in a clean oven at a temperature of 150° C. for 15 min.

Next, as shown in FIG. 3C, the polyamic acid film 15 was attached to the first substrate 11 so as to cover the recess 12 and the first flow path 13. The polyamic acid film 15 was attached using a roller method by which pressure and heat could be applied. Next, the attachment member 14 was peeled off, while being bent, from the attached polyamic acid film 15.

Next, as shown in FIG. 3D, the polyamic acid film 15 attached to the first substrate 11 was baked for imidization while being supported by the support member 16. A silicon substrate was used as the support member 16. The baking for imidization was performed at 350° C. for 1 h in a nitrogen atmosphere. The polyamic acid film 15 was reacted to the polyimide film 25 by heat treatment.

Next, as shown in FIG. 3E, the support member 16 was thinned by grinding, and then removed by etching. This resulted in the formation of a flow path member having the polyimide film 25 as a damper film arranged to cover the recess 12 and the first flow path 13.

Next, the outer surface of the polyimide film 25 was subjected to plasma treatment under the following conditions using a plasma device MAS8220AT (manufactured by Canon Inc.).

(Conditions) 16° C., 0 W, 90 s

Then, as shown in FIG. 3F, a silane agent VM-652 (manufactured by HD Microsystems, Inc.) was applied to the polyimide film 25 by spin coating at 2000 rpm for 30 sec to form the silane agent layer 26. The reaction between the functional groups on the surface of the polyimide film 25 and the silane agent was promoted by heating on a hot plate at 90° C. for 90 sec.

Next, as shown in FIG. 3G, the positive photoresist 33 was formed as an etching mask on the silane agent layer 26 to prevent the polyimide film 25 and the silane agent layer 26 formed on areas other than the first flow path 13 from being removed.

Then, as shown in FIG. 3H, the photoresist 33 formed on the first flow path 13 was removed by photolithography.

Next, as shown in FIG. 3I, the polyimide film 25 and the silane agent layer 26 on the first flow path 13 were removed by chemical dry etching. A mixture of O₂ gas and CF₄ gas was used as the etching gas. After the dry etching, the etching mask was removed by oxygen ashing.

Finally, the first substrate 11 and the second substrate 21 for forming the second flow path 23 (FIG. 1) communicating with the polyimide film were joined using divinylsiloxane-bisbenzocyclobutene (CYCLOTENE 3022-47, manufactured by Dow Chemical Company, hereafter referred to as BCB adhesive) as an adhesive.

### Example 1

### 2. Preparation of Evaluation Sample

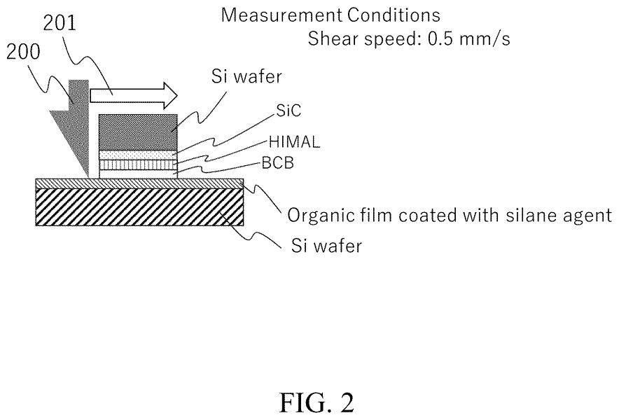

As an evaluation sample to be used for the evaluation of adhesion, a bonded body in which a substrate, an adhesive, and an organic film were adhered was prepared. The adhesion was evaluated by evaluating the die shear between the organic film and the adhesive before and after immersion in ink (FIG. 2).

### 2-1. Preparation of Organic Film to Be Used for Evaluation Sample

A support on which the organic film used in this study was formed was prepared by the steps in FIGS. 3A to 3I described above.

First, a support made of single crystal silicon was prepared. Furthermore, a silane coupling agent VM-652 (manufactured by HD Microsystems, Inc.) was applied to the polyamic acid film attachment surface of the support at 2000 rpm for 30 sec. This improved the adhesion between the support and the polyamic acid film. The silane coupling agent was baked by heating on a hot plate at 90° C. for 90 sec.

Next, a polyamic acid film was formed by applying a polyamic acid solution PI2610 (HD Microsystems, Inc.) on the silane coupling agent by spin coating (conditions: 2500 rpm, 30 sec). Next, the substrate was baked in a clean oven at 150° C. for 15 min.

Polyamic acid (polyamide acid) is a precursor of polyimide and can be obtained, for example, by reacting an aromatic diamine with a tetracarboxylic dianhydride in an organic solvent such as N-methylpyrrolidone.

Then, the polyamic acid film attached to the substrate was reacted into a polyimide film by using a clean oven and heating at 340° C. for 2 h.

Finally, the polyimide film on the substrate, which had the polyimide film as the outermost surface, was subjected to plasma treatment under the following conditions using a plasma device MAS8220AT (manufactured by Canon Inc.) to obtain an organic film-coated support.

(Conditions) 16° C., 0 W, 90 s

### 2-2. Coating of Silane Agent

The silane agent VM-652 (manufactured by HD Microsystems Inc.) was applied to the organic film-coated support, which was prepared as described in 2-1, by spin coating at 2000 rpm for 30 sec. Then, the reaction between the silane agent and the functional groups present in the surface layer of the organic film-coated film support was promoted by performing heating on a 90° C. hot plate for 90 sec.

Since the bonds formed between the organic film and the silane agent differ among the Examples, the bonds generated in Examples 1 to 16 are summarized in Table 4 below.

### 2-3. Preparation of Bonded Body

Meanwhile, the BCB adhesive diluted with a solvent was applied onto a release film using a spin coater at 2500 rpm for 30 sec. After that, the release film coated with the BCB adhesive was heated in an oven heated to 100° C.

Next, a silicon chip (Si substrate with a SiC film formed thereon) was prepared with a surface layer coated with a polyetheramide HIMAL HL-1200CH (manufactured by Showa Denko Materials Co., Ltd.). This silicon chip coated with HIMAL serves as the substrate to which the organic film is to be bonded with the BCB adhesive, which is an adhesive.

This silicon chip was diced and pressed against the BCB adhesive on the release film coated with BCB on a hot plate heated to 100° C., thereby applying the BCB adhesive to the surface of the silicon chip (substrate). The reason for this is that the BCB adhesive is in a cured state at room temperature, but when heated to 100° C., it becomes fluid and can be applied to the silicon chip surface. The BCB adhesive on the silicon chip surface was then solidified by allowing to stand at room temperature for 3 min.

Furthermore, the organic film-coated support coated with the silane agent, which was prepared as described in 2-2, was heated to 100° C., and the silicon chip coated with the BCB adhesive described above was pressed thereagainst. This caused the BCB adhesive to temporarily fluidize between the silicon chip (substrate) and the support, filling the gap between the chip and the support. The BCB adhesive was then cured by allowing to stand at room temperature for 1 h.

After curing, the evaluation sample was heated at 250° C. for 1 h to promote the reaction between the BCB adhesive and the silane agent, resulting in a bonded body in which the substrate, adhesive, and organic film were bonded.

This generated silanol groups, which reacted with the silane agent to generate covalent bonds, including siloxane bonds, between the silane coupling agent and the BCB adhesive. Since covalent bonds such as shown in Table 4 have been formed between the organic film and the silane agent, the organic film and the adhesive become bonded through siloxane bonds.

### 2-4. Evaluation

Immediately after the bonded body was obtained, the adhesion between the polyimide and the BCB adhesive was evaluated using the die shear strength measurement method illustrated by FIG. 2.

First, an organic film-coated support with a silicon chip, which is a substrate, thereon was prepared. Then, the silicon chip was pressed in the direction of an arrow 201 with a tool 200 as shown in FIG. 2. The pressing force was gradually increased, and the value of the pressing force when the pattern peeled off was measured to evaluate the adhesion. The value of the pressing force when the pattern peeled off is called the “die shear strength”, and the higher this value is, the greater the adhesion between the polyimide and the BCB adhesive.

More specifically, the measurement was performed using a bond tester DAGE 4000Plus (manufactured by Nordson Advanced Technology Co., Ltd.) under the following conditions.

Tool movement speed: 0.5 mm/s

Next, the organic film-coated support with the silicon chip, which is a substrate, thereon was immersed in water-based ink and removed again after 30 days. After the removal, the adhesion was measured using the same procedure as after the end of baking.

The composition of the water-based ink is shown in Table 1-1 below.

Table 1-2 shows the composition of the organic ink, which will be described hereinbelow.

TABLE 1-1

| Component | Content ratio (wt %) |
|---|---|
| Water | 70 |
| Glycerol | 30 |

TABLE 1-2

| | Content ratio |
|---|---|
| Component | (wt %) |
| (5-Ethyl-1,3-dioxan-5-yl)methyl = acrylate | 50 |
| Propoxylated neopentyl glycol diacrylate | 30 |
| 2-Propenoic acid | 5 |
| Ethyl 4-diethylaminobenzoate | 5 |
| Alcohol (type is not disclosed) | 2.5 |
| Di(trimethylolpropane) tetraacrylate | 2.5 |
| Trimethylolpropane triacrylate | 2.5 |
| Hexamethylene diacrylate (HDDA) | 1 |
| Phenylbis(2,4,6-trimethylbenzoyl) phosphine-oxide | 1 |

### Example 2

The conditions were the same as in Example 1, except that the ink used in the evaluation was changed to an organic ink.

### Example 3

The conditions were the same as in Example 1, except that YL9028 (Mitsubishi Chemical Corporation) was used as the adhesive instead of the BCB adhesive. The details of the structure of YL9028 are not disclosed, but it is disclosed that the structure has a siloxane bond Si—O—Si.

### Example 4

The conditions were the same as in Example 3, except that the ink used in the evaluation was changed to an organic ink.

### Example 5

The conditions were the same as in Example 1, except that the epoxy silane agent AP3000 (DuPont) was used as the silane agent instead of VM652.

### Example 6

The conditions were the same as in Example 5, except that the ink used in the evaluation was changed to an organic ink.

### Example 7

The conditions were the same as in Example 5, except that YL9028 (Mitsubishi Chemical Corporation) was used as the adhesive instead of the BCB adhesive.

### Example 8

The conditions were the same as in Example 7, except that the ink used in the evaluation was changed to an organic ink.

### Example 9

The conditions were the same as in Example 1, except that a photosensitive epoxy resin (composition: Table 2) was used instead of the polyamic acid solution PI2610 used in the organic film.

TABLE 2

| | Name of | | Number |
|---|---|---|---|
| Structure | material | Manufacturer | of parts |
| Bifunctional or | EPICLON | DIC | 100 |
| higher epoxy resin | N695 | | |
| Bifunctional | jER 1009F | Mitsubishi | 200 |
| epoxy resin | | Chemical | |
| Polyhydric alcohol | PEG600 | — | 8 |
| Photoacid generator | SP-172 | ADEKA | 5 |
| Silane coupling agent | A-187 | Momentive | 11 |
| | | Performance | |
| | | Materials | |
| Solvent | PGMEA | — | 700 |

### Example 10

The conditions were the same as in Example 9, except that the ink used in the evaluation was changed to an organic ink.

### Example 11

The conditions were the same as in Example 9, except that YL9028 (Mitsubishi Chemical Corporation) was used as the adhesive.

### Example 12

The conditions were the same as in Example 11, except that the ink used in the evaluation was changed to an organic ink.

### Example 13

The conditions were the same as in Example 9, except that the epoxy silane agent AP3000 was used as the silane agent instead of VM652.

### Example 14

The conditions were the same as in Example 13, except that the ink used in the evaluation was changed to an organic ink.

### Example 15

The conditions were the same as in Example 13, except that YL9028 (Mitsubishi Chemical Corporation) was used as the adhesive.

### Example 16

The conditions were the same as in Example 15, except that the ink used in the evaluation was changed to an organic ink.

### Comparative Example 1

The conditions were the same as in Example 1, except that a urethane adhesive KU550 (Konishi Co., Ltd.) was used as the adhesive.

### Comparative Example 2

The conditions were the same as in Comparative Example 1, except that the ink used in the evaluation was changed to an organic ink.

### Comparative Example 3

The conditions were the same as in Example 1, except that no silane agent was used.

### Comparative Example 4

The conditions were the same as in Comparative Example 3, except that the ink used in the evaluation was changed to an organic ink.

The above levels are summarized in Tables 3-1 to 3-3.

TABLE 3

| | Example No. | | | | | | | |
|---|---|---|---|---|---|---|---|---|
| | 1 | 2 | 3 | 4 | 5 | 6 | 7 | 8 |
| Organic film | Polyimide | Polyimide | Polyimide | Polyimide | Polyimide | Polyimide | Polyimide | Polyimide |
| Silane agent | Aminosilane | Aminosilane | Aminosilane | Aminosilane | Epoxy silane | Epoxy silane | Epoxy silane | Epoxy silane |
| | agent | agent | agent | agent | agent | agent | agent | agent |
| Adhesive | BCB | BCB | YL9028 | YL9028 | BCB | BCB | YL9028 | YL9028 |
| Type of ink | Water | Organic | Water | Organic | Water | Organic | Water | Organic |
| Initial | A | A | A | A | A | A | A | A |
| adhesion | | | | | | | | |
| Ink durability | A | A | A | B | A | B | A | C |

| | Example No. | | | | | |
|---|---|---|---|---|---|---|
| | 9 | 10 | 11 | 12 | 13 | 14 |
| Organic film | Photosensitive | Photosensitive | Photosensitive | Photosensitive | Photosensitive | Photosensitive |
| | epoxy | epoxy | epoxy | epoxy | epoxy | epoxy |
| Silane agent | Aminosilane | Aminosilane | Aminosilane | Aminosilane | Epoxy | Epoxy |
| | agent | agent | agent | agent | silane agent | silane agent |
| Adhesive | BCB | BCB | YL9028 | YL9028 | BCB | BCB |
| Type of ink | Water | Organic | Water | Organic | Water | Organic |
| Initial | A | A | A | A | A | A |
| adhesion | | | | | | |
| Ink durability | A | B | A | C | A | B |

| | Example No. | | | | | |
|---|---|---|---|---|---|---|
| | | | Comparative | Comparative | Comparative | Comparative |
| | 15 | 16 | Example1 | Example2 | Example3 | Example4 |
| Organic film | Photosensitive | Photosensitive | Polyimide | Polyimide | Polyimide | Polyimide |
| | epoxy | epoxy | | | | |
| Silane agent | Epoxy | Epoxy | Aminosilane | Aminosilane | None | None |
| | silane agent | silane agent | agent | agent | | |
| Adhesive | YL9028 | YL9028 | KU550 | KU550 | BCB | BCB |
| Type of ink | Water | Organic | Water | Organic | Water | Organic |
| Initial | A | A | B | B | B | B |
| adhesion | | | | | | |
| Ink durability | A | C | D | D | D | D |

### Evaluation Results

The evaluation results are shown below.

In the present study, since the initial die shear strength was 9.9 kgf when the workpiece was produced without any silane agent treatment following the prior art, the initial die shear strength (initial adhesion) was set to be 10 kgf or more as a prerequisite. Furthermore, the adhesion was ranked as A, B, C, or D according to the degree of decrease of the die shear strength after immersion in ink from the initial value.

These criteria are summarized as follows.

### Initial Adhesion

A: Initial adhesion of 10 kgf or more
B: Initial adhesion of less than 10 kgf

### Adhesion After Immersion in Ink

A: Adhesion after immersion in ink for 30 days is 95% or more of the initial adhesion
B: Adhesion after immersion in ink for 30 days is 85% or more and less than 95% of the initial adhesion
C: Adhesion after immersion in ink for 30 days is 75% or more and less than 85% of the initial adhesion
D: Adhesion after immersion in ink for 30 days is less than 75% of the initial adhesion

### Type of Organic Film

First, in the Examples, the initial adhesion of 10 kgf or more was obtained for both polyimide and photosensitive epoxy organic films, and the die shear strength maintained 75% or more of the initial value even after immersion in ink.

However, comparing Example 2 and Example 10, the results suggest that when organic ink was used, the organic film made of polyimide had a higher ability to maintain adhesion to the ink than the organic film made of photosensitive epoxy. This is believed to be because epoxy groups are more hydrophilic and lipophilic than imide compounds, so have a higher affinity for the solvent in the ink and are more likely to swell.

### Type of Silane Agent

In the Examples, the initial adhesion of 10 kgf or more was obtained when the silane agent was an aminosilane agent or an epoxy silane agent, and the die shear strength maintained 75% or more of the initial value even after immersion in ink. In addition, by comparing with Comparative Examples 3 and 4, which did not use a silane agent, it can be confirmed that the silane agent is effective in improving adhesion. This is believed to be because the silane agent bonds the organic film and the adhesive through siloxane bonds, thereby strengthening the bond between the organic film and the adhesive.

In the cases of Comparative Examples 3 and 4, even without using a silane agent, ester bonds are formed between the carboxyl groups on the organic film surface and the hydroxyl groups of the adhesive, but since the siloxane bonds formed in the Examples have higher water and oil repellency, it is believed that the durability to ink is higher.

### Bonds Between Organic Film and Silane Agent

The bonds formed in the combination of organic film and silane agent used in the present Examples are as shown in Table 4.

TABLE 4

| Example No. | Name of bond | Structure of bonded portion |
|---|---|---|
| 1 to 4 | Amido bond | R1—CO—NH—R2 |
| 5 to 8 | Epoxy ester bond | R1—CH₂—CHOH—CH₂—O—CO—CH₂—CH₂—R2 |
| 9 to 12 | Secondary amine | R1—CHOH—CH₂—N—R2 |
| 13 to 16 | No name | R1—CH—(CH₂—O—CH₂)—CH₂—R2 |

The presence of siloxane bonds between the organic film and the adhesive can improve adhesion, but the results in Table 4 suggest that adhesion is further improved when there are bonds represented by the following general formulas between the organic film and the silane agent. That is, as mentioned above, it is preferable to comprise a bond represented by formula (1) in addition to siloxane bonds between the organic film and the adhesive.

### General Formulas for Bonds Between Organic Film and Silane Agent

R1-CO—NH—R2,

R1-CH₂—CHOH—CH₂—O—CO—CH₂—CH₂—R2,

R1-CHOH—CH₂—N—R2,

R1-CH₂—(CH₂—O—CH₂)n-CH₂—R2

R1 and R2 indicate the bonding sites with the organic film and silane agent, for example, a carbon atom at the end of the organic film and silane agent.

Also, n is the average number of moles added, and is an integer of, for example, 1 to 200, preferably 10 to 200.

### Type of Adhesive

When BCB adhesive or YL9028, which has silanol groups, was used as the adhesive, an initial adhesion of 10 kgf or more was obtained regardless of the type of organic film or silane agent, and the die shear strength maintained 75% or more of the initial value even after immersion in ink. Meanwhile, when the urethane adhesive KU-550 was used as the adhesive, adhesion was significantly reduced, and 75% of the initial die shear strength was not achieved after immersion in ink. From this, it is believed that the generation of siloxane bonds, which have both strong covalent bonds and water repellency, between the adhesive and the organic film is an essential requirement for improving adhesion.

Furthermore, comparing the BCB adhesive with YL9028, for example, when comparing Examples 2 and 4, it was shown that the BCB adhesive had slightly better adhesion and ink resistance. This is thought to be because epoxy groups are more hydrophilic and lipophilic than imide compounds, and therefore have a high affinity for the solvents in the ink and are more likely to swell.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions. This application claims the benefit of Japanese Patent Application No. 2024-022601, filed Feb. 19, 2024, which is hereby incorporated by reference herein in its entirety.

What is claimed is:

1. A liquid ejection head comprising:
an ejection port for ejecting liquid;
a pressure chamber in which pressure acts on the liquid ejected from the ejection port;
a flow path communicating with the pressure chamber;
a substrate forming the flow path; and
an organic film for constituting a part of a wall surface of the flow path and suppressing vibration of the liquid in the flow path, wherein
the organic film is adhered, with an adhesive, to the substrate, and
the organic film and the adhesive are bonded through a siloxane bond.

2. The liquid ejection head according to claim 1, wherein
the liquid ejection head comprises a bond represented by a following formula (1) in addition to the siloxane bond between the organic film and the adhesive, and a silane agent is present between the organic film and the adhesive:
—R1-X—R2- (1)
in formula (1), X is
at least one selected from the group consisting of —CO—NH—, —CH₂—CHOH—CH₂—O—CO—CH₂—CH₂—, —CHOH—CH₂—N—, —CH₂—(CH₂—O—CH₂)n-CH₂—, —CO—O—, —CO—S—, —O—, and —NH—CO—O—,
n is an average number of moles added and represents an integer of 1 to 200, and
R1 and R2 indicate the bonding sites with the organic film and the silane agent.

3. The liquid ejection head according to claim 1, wherein the organic film comprises a polyimide.

4. The liquid ejection head according to claim 1, wherein a portion of the organic film in contact with the adhesive is treated with plasma.

5. The liquid ejection head according to claim 1, wherein
adhesion between the organic film and the adhesive comprises a bond through a silane agent, and
the silane agent comprises an aminosilane agent.

6. The liquid ejection head according to claim 1, wherein the adhesive comprises a resin comprising a cyclobutene skeleton.

7. The liquid ejection head according to claim 1, wherein the adhesive comprises divinylsiloxane-bisbenzocyclobutene.

8. The liquid ejection head according to claim 1, further comprising an ejection element that generates pressure, the ejection element being a piezoelectric element.
